(19) United States
(12) Patent Application Publication
(10) Pub. No.: US 2025/0121601 A1
(43) Pub. Date: Apr. 17, 2025

(54) SILCONE TAPE HAVING IMPROVED ADHESIVE PROPERTIES

(71) Applicant: Funai Electric Co., Ltd., Osaka (JP)

(72) Inventor: Jacob Boyle, Lexington, KY (US)

(73) Assignee: Funai Electric Co., Ltd., Osaka (JP)

(21) Appl. No.: 18/479,180

(22) Filed: Oct. 2, 2023

(51) Int. Cl. B41J 2/175; C09J 5/00; C09J 7/38

(52) U.S. Cl. CPC B41J 2/17536; B41J 2/17533; B41J 2/17553; C09J 5/00; C09J 7/38; C09J 2203/37; C09J 2301/208; C09J 2483/00

(57) ABSTRACT

A removable tape configured for sealing the nozzle plate of an ejection head and a method for making the removable tape. The removable tape includes a polymeric backing film; a first platinum-cured silicone adhesive layer having a first adhesive strength applied to the polymeric backing film; and a second platinum-cured silicone adhesive layer having a second adhesive strength applied to the first adhesive layer. The second platinum-cured adhesive layer is configured to adhere to the nozzle plate of a fluid ejection cartridge.

### TECHNICAL FIELD

This disclosure relates to the field of fluidic ejection cartridges. More particularly, this disclosure relates to an improved sealing tape for use on fluidic ejection cartridges.

### BACKGROUND

Thermal inkjet printing has existed for decades as a way to eject fluid onto a substrate. Traditionally, inkjet printers were used to print water-based inks on paper, typically in home or office settings. Currently, however, due to a decline in at-home printing, the inkjet printing market has shifted toward commercial and industrial applications. Commercial inkjet printing consumers use aggressive solvents and ink formulations to print on a wide variety of materials including steel, glass, and cardboard. Accordingly, due to this shift, there is a demand for fluid ejection heads and cartridges that are durable for use with non-conventional fluid formulations.

In some instances, fluid ejection cartridges may spend the majority of their lifespan in transit from manufacture and/or in storage prior to installation or use. Consequently, it is important that cartridge operability does not degrade during transit or storage, even if the cartridge remains in storage for an extended period of time. Typically, to maintain cartridge operability, a protective sealing tape or a plastic cover containing a resilient seal covers the ejection head and ejection nozzles on the ejection head. Both the plastic cover and the sealing tape are designed to prevent contamination of the ejection head, prevent seepage of fluid from the ejection head, and reduce the amount of solvent evaporated from the fluid in the cartridge during shipping and storage. Prior to use, the plastic cover or sealing tape is removed from the fluidic ejection cartridge, exposing the ejection nozzles. The plastic cover is effective in maintaining operability but is significantly more expensive than protective sealing tape.

Conventional pressure sensitive adhesive (PSA) sealing tapes that are used to seal the nozzle holes in an ejection head typically contain an acrylic adhesive with a polyvinyl chloride or polyethylene terephthalate backing film. These conventional acrylic adhesives are suitable for use with water-based inks but may be solubilized by harsher solvents and fluid formulations used in commercial and industrial applications, causing fluid leakage from the fluidic ejection cartridge and/or premature peeling of the tape from the ejection head. Thus, to ensure the protective sealing tape does not prematurely peel off the ejection head, a suitable tape and adhesive system must be found that will not be readily solubilized by these harsh solvents and ink formulations. The sealing tape must also be stable when exposed to heat during shipping and storage and must be capable of being completely removed from the ejection head without leaving an adhesive residue or damaging the underlying nozzle plate of the printhead while also staying firmly attached to the backing film. Accordingly, what is needed is an improved adhesive tape sealing system that can be used with fluidic ejection cartridges that contain a wider variety of fluids and solvents.

### SUMMARY

With regard to the foregoing, an embodiment of the disclosure provides an improved removable tape for a fluidic ejection cartridge and a method for making the improved removable tape. An advantage of the disclosed embodiments is that the removable adhesive tape material may be tailored to a fluid ejection cartridge containing a wide variety of fluids and solvents by using a backing material having two layers of platinum-cured adhesive materials having different peel strengths. The removable adhesive tape material may also be tailored to have improved chemical resistance to the fluids used in the fluid ejection cartridge, by having a greater thickness of an adhesive layer having the greater adhesive strength applied directly to the backing material.

In one aspect of the disclosure, a removable tape is configured for sealing a nozzle plate attached to an ejection head and to a portion of a fluid ejection cartridge body containing the ejection head. The removable tape includes a polymeric backing film; a first platinum-cured silicone adhesive layer having a first adhesive strength applied to the polymeric backing film; and a second platinum-cured silicone adhesive layer having a second adhesive strength applied to the first adhesive layer. The second platinum-cured adhesive layer is configured to adhere to the nozzle plate on the ejection head of the fluid ejection cartridge.

In some embodiments, the polymeric backing film may be selected from polyethylene terephthalate (PET), polypropylene, polyamide, and polyimide.

In some embodiments, the polymeric backing film has a thickness ranging from about 20 to about 30 microns, the first platinum-cured silicone adhesive layer has a thickness on the polymeric backing film ranging from about 7 to about 20 microns, and the second platinum-cured silicone adhesive layer has a thickness on the first platinum-cured silicone adhesive layer ranging from about 7 to about 20 microns.

In some embodiments, the polymeric backing film may comprise a corona-treated polymeric backing film.

In some embodiments, the first adhesive strength is greater than the second adhesive strength.

In some embodiments, the first platinum-cured silicone adhesive layer and second platinum-cured silicone adhesive layer may comprise different platinum-cured silicone adhesive base materials.

In some embodiments wherein the first and second platinum-cured silicone adhesive base materials are different, the first adhesive strength may have a peel strength ranging from about 150 to about 500 Newtons/meter (N/m) on a dry silicon wafer and the second adhesive strength has a peel strength ranging from about 25 to about 65 N/m on a dry silicon wafer.

In some embodiments, the first platinum-cured silicone adhesive layer and second platinum-cured silicone adhesive layer may comprise the same platinum-cured adhesive base material.

In some embodiments wherein the first and second platinum-cured silicone adhesive base materials are the same, the first adhesive strength has a peel strength ranging from about 150 to about 500 Newtons/meter (N/m) on a dry silicon wafer and the second adhesive strength has a peel strength ranging from about 25 to about 65 N/m on a dry silicon wafer.

In another aspect, the disclosure provides a method for making the removable tape configured for sealing the nozzle plate. The method comprises providing a polymeric backing film and mixing a crosslinker mixture comprising platinum siloxane complex catalyst and polydimethylsiloxane (PDMS) and polymethylhydrosilane (PMHS) with a first platinum-cured silicone adhesive base material to provide a first platinum-cured silicone adhesive and with a second platinum-cured silicone adhesive base material to provide a second platinum-cured silicone adhesive. The method further comprises applying a first layer of the first platinum-cured silicone adhesive with a first adhesive strength to the polymeric backing film and applying a second layer of the second platinum-cured silicone adhesive with a second adhesive strength to the first layer. The method further comprises curing the first and second adhesive layers.

In certain embodiments, the method comprises curing the first and second layers of platinum-cured silicone adhesive sequentially. In one variation of this embodiment, the curing step comprises first partially curing the layer of first platinum-cured silicone adhesive at a temperature of at least about 90° C. for about 1 minute, and then curing the layers of first and second platinum-cured silicone adhesives together at a temperature ranging from about 120° C. to about 150° C. for about 2 minutes to about 3 minutes.

In certain embodiments, the method comprises curing the first and second layers of platinum-cured silicone adhesive simultaneously. In one variation of this embodiment the first and second adhesive layers are cured simultaneously at a temperature ranging from about 120° C. to about 150° C. for about 2 minutes to about 3 minutes.

In certain embodiments, the first platinum-cured silicone adhesive layer and second platinum-cured silicone adhesive layer comprise different platinum-cured adhesive base materials.

In certain embodiments, the first platinum-cured silicone adhesive and second platinum-cured silicone adhesive comprise the same platinum-cured adhesive base materials.

In variations of the embodiment where the first and second adhesive base materials are the same, the method may further comprise mixing a first amount of crosslinker mixture with the first platinum-cured silicone adhesive base material and a second amount of crosslinker mixture with the second platinum-cured silicone adhesive base material, wherein the second amount of crosslinker mixture is greater than the first amount of crosslinker mixture.

In another aspect, the disclosure provides a method for improving the sealing of a nozzle plate of an ejection head attached to a fluidic ejection cartridge containing a fluid. The method comprises providing a cartridge body having a cover closing a first end thereof, the ejection head on a second end thereof opposite the first end, and side walls attached to the first and second ends between the first and second ends. The side walls include a first side wall, a second side wall opposite the first side wall, a first end wall attached to the first and second side walls, and a second end wall opposite the first end wall attached to the first and second side walls. The method further comprises attaching a removable tape to the nozzle plate of the ejection head and to a portion of cartridge body. The removable tape comprises a polymeric backing film and a platinum-cured silicone adhesive layer, the adhesive layer having a first adhesive strength adjacent to the backing film and a second adhesive strength less than the first adhesive strength adjacent to the nozzle plate.

In some embodiments, the first adhesive strength has a peel strength on a dry silicon wafer ranging from about 150 to about 500 Newtons/meter (N/m) on a dry silicon wafer and the second adhesive strength has a peel strength ranging from about 25 to about 65 N/m on a dry silicon wafer.

In some embodiments, the modified platinum-cured silicone adhesive layer has a thickness on the polymeric backing film ranging from about 20 to about 30 microns.

The disclosed embodiments provide a unique adhesive tape that includes two adhesive layers that is configured to provide a removable protective tape for an ejection head of a fluid cartridge that is suitable for use with a wide range of ejection fluids.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a side perspective view of a fluidic ejection cartridge according to an embodiment of the disclosure.

FIG. 2 is an end perspective view of the fluidic ejection cartridge of FIG. 1.

FIG. 3 is a top perspective view of an ejection head for the fluidic ejection cartridge of FIG. 1.

FIG. 4 is a schematic exploded view, not to scale, of the fluidic ejection cartridge of FIG. 1.

FIG. 5 is a perspective view, not to scale, of a protective sealing tape and pull tape for protecting the ejection head of the fluidic ejection cartridge of FIG. 1.

FIG. 6 is a cross-sectional view, not to scale, of the protective sealing tape according to a first embodiment of the disclosure.

FIG. 7 is a cross-sectional view, not to scale, of the protective sealing tape according to a second embodiment of the disclosure.

### DETAILED DESCRIPTION

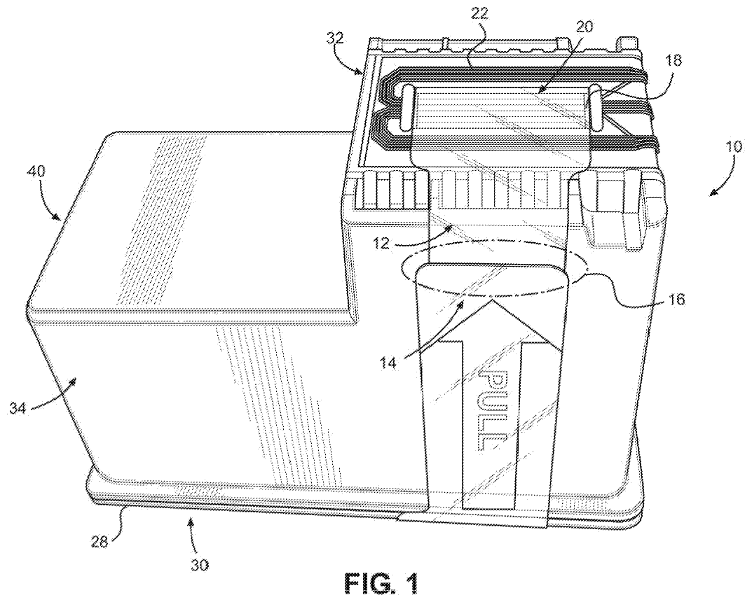

With reference to FIG. 1, there is shown a fluid ejection cartridge 10 containing a protective sealing tape 12 and a pull tape 14 overlapping a portion 16 of the protective sealing tape 12. The protective sealing tape 12 is used to cover a nozzle plate 18 of an ejection head 20 attached to the fluid ejection cartridge 10. The protective sealing tape 12 prevents contamination and damage to the ejection head 20, and seals nozzle holes in the nozzle plate 18 so that fluid in the fluid ejection cartridge 10 does not leak out or dry out and plug the nozzle holes during shipping and storage of the fluid ejection cartridge 10.

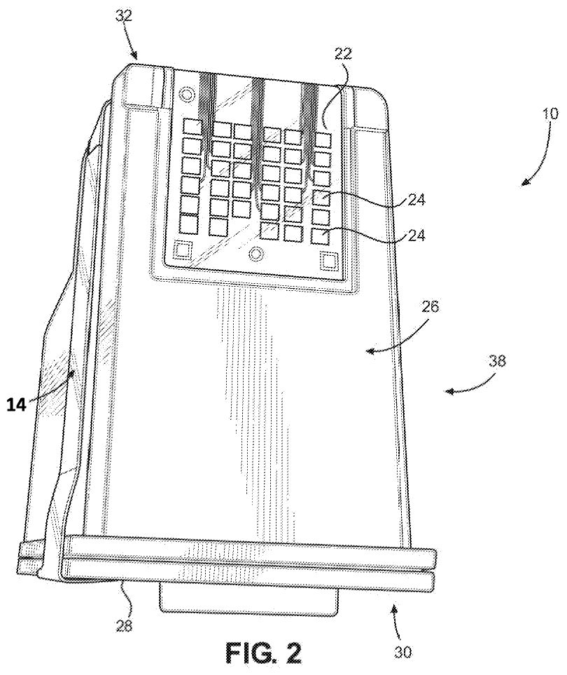

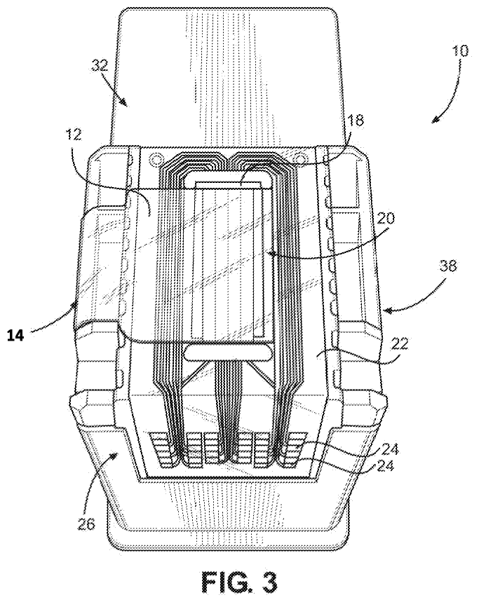

As shown in FIG. 2, a flexible circuit 22 is electrically connected to the ejection head 20 to control ejection of fluid from the fluid ejection cartridge 10 when the fluid ejection cartridge 10 is in use. The flexible circuit has electrical contacts 24 thereon that are disposed on a first end wall 26 of the fluid ejection cartridge 10 for electrical connection to a fluid ejection device, such as a printer, inhaler, E-cigarette, digital dispense system, and the like (not shown). A cover 28 is attached to a first end 30 of the fluid ejection cartridge 10 opposite a second end 32 of the fluid ejection cartridge that contains the ejection head 20. The pull tape 14 and protective sealing tape 12 are removably attached to the fluid ejection cartridge body such as to a first side wall 34 of the fluid ejection cartridge 10 (FIG. 1). The fluid ejection cartridge 10 also contains a second side wall 38 opposite the first side wall 34 and a second end wall 40 opposite the first end wall 26.

Before the cartridge 10 is installed and used in the fluid ejection device, the pull tape 14 is peeled away from the body of the fluid ejection cartridge 10 by grasping a tab on one end of the pull tape 14 and pulling the pull tape 14 away from the body of the fluid ejection cartridge 10. As the pull tape 14 is removed from the fluid ejection cartridge 10, the protective sealing tape 12—attached to the pull tape 14 in the overlapping area 16—is also removed from the fluid ejection cartridge 10 so that fluid can then be ejected from the ejection head 20.

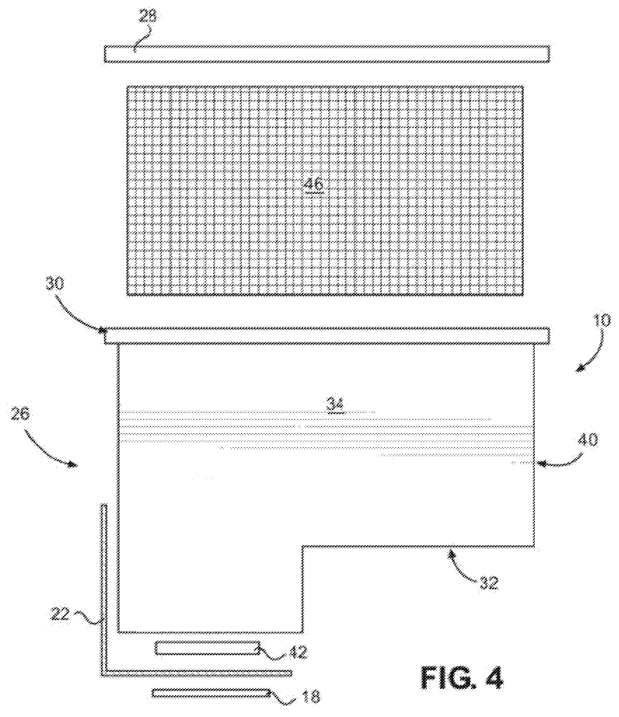

Further details of the fluid ejection cartridge 10 may be seen in an exploded view of the fluid ejection cartridge 10 illustrated schematically in FIG. 4. The ejection head 20 includes a semiconductor substrate 42 to which the flexible circuit 22 is electrically attached and the nozzle plate 18 is attached to the semiconductor substrate 42 in a window (not shown) of the flexible circuit 22. In some embodiments, the fluid ejection cartridge 10 is filled with an open cell foam material 46 that holds fluid to be ejected from the ejection head 20 and provides a backpressure on the fluid to reduce drooling of fluid from the ejection head 20. In other embodiments, the body of the fluid ejection cartridge 10 is devoid of a backpressure device.

In embodiments described herein, the protective sealing tape 12 is used to cover and protect nozzle holes on the nozzle plate 18 as described above. The protective scaling tape 12 has a polymeric base film layer or “backing film” 50 (shown in FIG. 6) in addition to one or more adhesive layers 51 (FIG. 6). The backing film 50 comprises polyethylene terephthalate, polypropylene, polyethylene, polybutene, polybutadiene, polymethyl pentene, polybutylene terephthalate, polyurethane, ethylene-vinyl acetate copolymer, ionomer resin, ethylene-(meth)acrylic acid copolymer, ethylene-alkyl meth (acrylate) copolymer, polystyrene, polyimide, polyamide, or polycarbonate and has a thickness of from about 10 to about 40 microns, preferably having a thickness of from about 20 to about 30 microns. A particularly preferred polymeric backing film material is polyimide.

It will be appreciated that the ejection head 20, with its semiconductor substrate 42 and nozzle plate 18, is a precisely manufactured device that is capable of high resolution fluid ejection. Accordingly, protection of the ejection head 20 is important for the proper operation of the fluid ejection device using the cartridge 10. As shown in FIG. 1, the protective sealing tape 12 is applied to the ejection head 20 and the body of the fluidic ejection cartridge 10 and the pull tape 14 is applied to the body of the fluidic ejection cartridge 10 adjacent an end of the protective sealing tape 12. In some embodiments, the protective sealing tape 12 is configured to be peeled from the ejection head 20 in a direction that is orthogonal to a longitudinal direction of the nozzle plate 18 and substrate 42. Such peeling direction is effective to reduce stresses that may occur to the ejection head 20 when the protective sealing tape 12 is peeled therefrom and reduces the likelihood that the nozzle plate 18 will delaminate from the substrate 42. Accordingly, it is desirable that the protective sealing tape 12 be peeled in the orthogonal direction rather than in a longitudinal direction with respect to the ejection head. Moreover, it is important that adhesive layer 51 or 52 of the protective sealing tape 12, such as protective sealing tapes 12a or 12b (FIGS. 6-7) contain few impurities since it is in intimate contact with the nozzle plate 18 and could contaminate the nozzle holes in the nozzle plate 18 thereby blocking the nozzle holes from functioning properly if any residue remains on the nozzle plate 18.

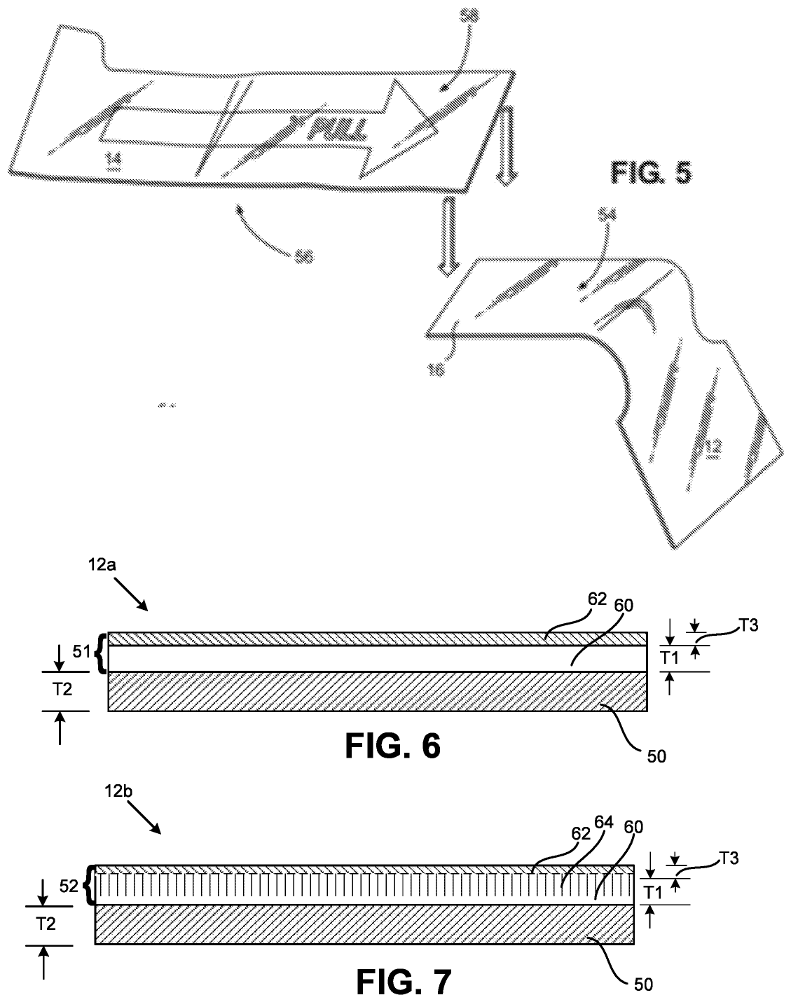

As shown in FIGS. 1 and 5, it is important that the pull tape 14 overlap the backside 54 of the protective sealing tape 12 to improve the removal of the protective scaling tape 12 from the cartridge 10. The adhesive material used on the underside 56 of the pull tape 14 is not particularly critical to the disclosed embodiments. Accordingly, the pull tape adhesive may be a pressure sensitive adhesive selected from various radiation curable polymers such as epoxy, diolefin, urethane, polyimide, acrylic, silicone, and vinyl ester polymers including a polymerization initiator. Examples of acrylic polymers which may be used include homopolymers or copolymers of an alkyl(meth)acrylate, and copolymers of (meth)acrylate and another copolymerizable monomer such as a hydroxyalkyl(meth)acrylate, glycidyl(meth)acrylate, (meth)acrylic acid, itaconic acid, maleic anhydride, (meth)acrylic amide, (meth)acrylic N-hydroxymethylamide, an alkylaminoalkyl(meth)acrylate, silicone adducted acrylate, vinyl acetate, styrene, or acrylonitrile. In addition to the acrylic and epoxy adhesive materials, polyimide and silicone based materials may also be used as base materials for the pressure sensitive adhesive layer on the underside 56 of the pull tape 14. The adhesive used on an underside 56 of the pull tape 14 has a peel strength of about 2 times greater and desirably at least about 3 time greater than the peel strength of the portion of the protective sealing tape 12 in contact with the nozzle plate.

Platinum-cured silicone based adhesives are suitable adhesive base materials for forming the adhesive layer of the protective sealing tape 12 that will contact and seal the nozzle holes in the nozzle plate 18. Platinum-cured silicon based adhesives have been found to be particularly chemically resistant to organic solvent-based fluids, thereby maintaining a suitable peel strength for a prolonged period of time while being exposed to the organic solvent-based fluid in the cartridge 10. Conventional adhesives, such as acrylic adhesive, peroxide-catalyzed silicone adhesive, natural and synthetic rubber based adhesive, and hot melt adhesives fail to maintain suitable peel strength, and/or fail to remain in place on the nozzle plate despite relatively high initial peel strengths.

The platinum-cured silicone adhesive, according to the disclosure, is made by cross-linking a silane group of polydimethylsiloxane (formula I) with a high molecular weight vinyl end-capped polydimethylsiloxane (formula II) in the presence of a platinum catalyst and heat to provide the platinum-cured silicone adhesive according to the following reaction:

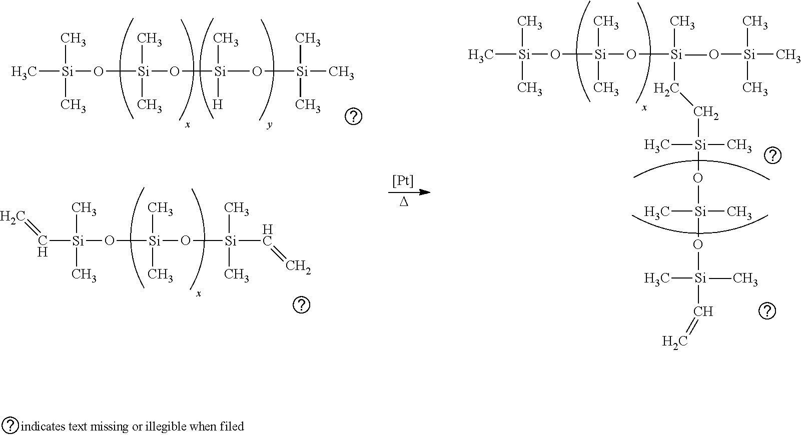

The foregoing cross-linked platinum cured silicone adhesives are highly resistant to organic solvents and provide a significantly improved adhesive tape for sealing the fluid jet ejection heads. The foregoing platinum-cured silicone adhesives were found to withstand the harsh environment better than acrylics, rubbers, synthetic rubbers, acrylic/rubber hybrids, or hot melt adhesives.

One issue arising in the use of platinum-cured silicone adhesives, however, is the need for suitable strengths of adhesion of the adhesive layer at two interfaces: at the interface of the adhesive layer and the nozzle plate 18 of ejection head 20, and at the interface of the adhesive layer and backing film 50. An adhesive layer comprising a single platinum-cured silicone adhesive layer will provide a single strength of adhesion at both interfaces, presenting the opportunity for failures within the protective sealing tape 12. For instance, if the strength of adhesion between the adhesive layer and nozzle plate 18 is too great, removal of the protective sealing tape 12 from ejection head 20 may damage the delicate photoresist layers of the ejection head 20—for instance, destruction of the channels formed between the nozzle plate 18 layer and fluid flow layer of the ejection head 20—rendering the cartridge non-functional. Likewise, if strength of adhesion between the adhesive layer and the backing film is too little, removal of the protective sealing tape 12 from ejection head 20 will cause the adhesive layer to remain adhered to the ejection head 20, preventing fluid flow from the cartridge 10 and again rendering the cartridge non-functional.

A conventional method of achieving the required balance and preventing failures at the nozzle plate is the addition of adhesive “deadening” agents to the tape formulation to lower the adhesion of the tape to an ideal level for both interfaces. For example, for acrylic-based adhesives used to seal printheads containing water-based ink formulations, the adhesive contains a plasticizer for lowering adhesion to an acceptable level. However, adhesive deadening agents tend to hinder the chemical resistivity of silicone-based adhesive formulations. Thus, a pure and unmodified silicone adhesive is preferable, to retain suitable chemical resistance.

Moreover, in order to improve the strength of adhesion between the adhesive layer and the polymeric backing film, a corona treatment of the backing film may be performed prior to coating the adhesive material onto the backing film. Additionally, an anchorage material may be added to the highly cross-linked adhesive formulation to improve the adhesion between the adhesive and the polymeric backing film. A suitable anchorage additive is 2-(3,4-epoxycyclohexyl)ethyltrimethoxysilane available from Dow Chemical Company under the trade name SYL-OFF 9176. The amount of anchorage additive in the adhesive formulation may range from about 0.2 to about 0.4 percent by weight based on a total weight of the adhesive formulation.

In furtherance of additional solutions, initial tests for potential suitable adhesive layer materials were conducted using various pure and unmodified platinum-cured silicone adhesive base materials, including materials from Dow Chemical Company, that provide varying adhesive strengths. Among others, some of the materials tested included platinum-cured silicone adhesive base materials under the trade names DOWSIL 7646, DOWSIL 7652, DOWSIL 7667, and DOWSIL 7657. Testing determined that DOWSIL 7667 provided nearly acceptable levels of adhesion. DOWSIL 7652 provided too little adhesion to the backing film and would remain on the nozzle plate 18, and DOWSIL 7657 provided too great adhesion, damaging the photoresist layers of the ejection head 20. While DOWSIL 7667 provided somewhat satisfactory adhesion results, the frequency of adhesion failures at both interfaces was unsatisfactory.

In order to solve the adhesion problems at the interfaces, it was determined that the adhesive layer may be formed from multiple layers of platinum-cured silicone adhesive base materials. By utilizing the similar chemistry of the platinum-cured silicone adhesive base materials and the same crosslinking mechanism, an adhesive layer with a rigid, high-adhesion structure on the side facing the backing film and a soft, low-adhesion structure on the side facing the nozzle plate may be prepared.

In one exemplary embodiment shown in FIG. 6, the adhesive layer 51 of sealing tape 12a may comprise two distinct layers. A first adhesive layer 60 that contacts the backing film 50 may comprise an adhesive base material that exhibits superior crosslinking and high adhesion in cured form at an expense of decreased wettability, such as DOWSIL 7657. A second adhesive layer 62 is applied to the first adhesive layer 60. The second adhesive layer 62, configured to contact the nozzle plate 18, may comprise one or more adhesive base materials that exhibits less crosslinking and lower adhesion in cured form, such as DOWSIL 7652, or a base material with higher adhesion and chemical resistance, such as DOWSIL 7667, mixed with a base material with lower adhesion, such as DOWSIL 7652, or DOWSIL 7646 in various proportions such as, but not limited to, 90% DOWSIL 7667 and 10% DOWSIL 7652 or DOWSIL 7646, to achieve an acceptable adhesive strength, or alternate formulations with other platinum-cured silicone adhesive base materials.

In another aspect, the first adhesive layer 60 and second adhesive layer 62 may comprise the same adhesive base material, but the strength of adhesion may be effectively “deadened” to acceptable levels depending on the mole ratio of crosslinker (I) added to the adhesive base material containing PDMS (II). This single adhesive base material method may decrease the manufacturing cost of the tape by eliminating the need for two different silicone adhesive base materials to create the above adhesive layer 51, and has adhesion strength characteristic that may be easily modified and optimized for various other applications while still retaining purity, at the expense of some chemical resistance of the modified material. In applications optimizing the strength of adhesion of the adhesive base material, the ideal mole ratio of crosslinker (I) to PDMS (II) in the adhesive base material is 2:1, which provides a 1:1 ratio of hydrogen to vinyl functional groups in the mixture of crosslinker (I) and PDMS (II). According to product literature regarding crosslinking by hydrosilation (addition), excess crosslinker degrades crosslink density and causes performance of the cured adhesive base material to suffer in the form of decreased strength of adhesion, crosslink density, tack, chemical resistance, and other performance characteristics. It has been found that any amount of crosslinker above the optimal amount results in some degradation of crosslink density and performance characteristics.

In one exemplary embodiment, the first adhesive layer 60 of adhesive layer 51 in contact with the backing film 50 may comprise an adhesive base material with greater strength of adhesion, such as DOWSIL 7657, formulated with the optimal mole ratio of 2:1 crosslinker (I) to PDMS (II) to retain sufficient chemical resistance, backer adhesion, and strength. The second adhesive layer 62 of the adhesive layer 51 configured to contact the nozzle plate 18 may comprise the same high strength of adhesion adhesive base material, such as DOWSIL 7657, formulated with a higher mole ratio of crosslinker to PDMS, such as, but not limited to, a mole ratio of 3:1, to reduce the strength of adhesion of the second adhesive layer 62 to the nozzle plate 18.

In another embodiment, the first adhesive layer 60 and second adhesive layer 62 may comprise different adhesive base materials, and the strength of adhesion may also be effectively “deadened” to acceptable levels depending on the mole ratio of crosslinker (I) to PDMS (II). In one exemplary embodiment, the first adhesive layer may comprise an adhesive base material with a greater strength of adhesion, such as DOWSIL 7657, formulated with the optimal mole ratio of 2:1 of crosslinker to PDMS to retain sufficient chemical resistance, backer adhesion, and strength. The second adhesive layer 62 of the adhesive layer 51 configured to contact the nozzle plate 18 may comprise adhesive base material with high chemical resistivity and higher strength of adhesion, such as DOWSIL 7667, formulated with a higher mole ratio of crosslinker to PDMS, such as, but not limited to, a mole ratio of 3:1, to reduce the strength of adhesion of the second adhesive layer 62 to the nozzle plate 18 while still retaining some increased chemical resistance.

Noted above, the peel strengths of the first adhesive layer 60 and second adhesive layer 62 are selected in order to avoid failures at both interfaces: the interface between the backing film 50 and the first adhesive layer 60 and the interface between the second adhesive layer 62 and the nozzle plate 18. Accordingly, the first adhesive layer 60 of adhesive layer 51 has a peel strength that in the range from about 150 N/m to about 500 N/m on a silicon wafer as determined using a 200-millimeter-wide sample at a peeling speed of 300 mm/min and at an angle of 90 degrees. This range corresponds to an acceptable strength of adhesion to avoid failure at the interface between the backing film 50 and the first adhesive layer 60. The second adhesive layer 62 of adhesive layer 51 has a peel strength that is in the range from about 25 N/m to about 65 N/m on a silicon wafer as determined using a 200-millimeter-wide sample at a peeling speed of 300 mm/min and at an angle of 90 degrees. This range corresponds to an acceptable strength of adhesion to avoid failure at the interface between the second adhesive layer 62 and the nozzle plate 18. Since the adhesive strength of the first adhesive layer 60 is greater than the adhesive strength of the second adhesive layer, it is unlikely that the second adhesive layer 62 would delaminate from the first adhesive layer 60.

The protective sealing tape 12 may be produced via a method using conventional sealing tape manufacturing equipment, such as slot dies. In one embodiment, the method comprises providing a polymeric backing film and preparing two different platinum-cured silicone adhesive compositions by mixing together two primary components: (1) a platinum-cured silicone base material, which may be supplied in premixed form in various Dow Chemical Company DOWSIL products such as DOWSIL 7652, 7657, 7646, and 7667, comprising MQ silicone resin, vinyl-capped linear siloxane base polymer such as polydimethylsiloxane or copolymers such as methylphenylsiloxane, and diphenylsiloxane, or similar compounds, and one or more solvents such as toluene, xylene, or ethylbenzene; and (2) a crosslinker mixture, comprising (a) a platinum siloxane complex catalyst such as platinum, 1,3-diethenyl-1,1,3,3-tetramethyldisiloxane complexes supplied in premixed form in various Dow Chemical Company products such as SYL-OFF 4000 Catalyst, and (b) a crosslinker comprising polydimethylsiloxane and polymethylhydrosilane, such as crosslinker supplied in premixed form in various Dow Chemical Company products such as SYL-OFF 7678, 7215, and 7660. The components are mixed in accordance with technical data sheets supplied by the manufacturer for each adhesive base material (except when deadening is desired, in which case excess crosslinker is used, above the optimal mole ratio of crosslinker to PDMS) to generate two different platinum-cured silicone adhesive base material compositions.

The method then comprises coating the backing film 50 with a first adhesive layer 60 of the platinum-cured silicone adhesive base material composition having higher strength of adhesion in cured form, such a composition comprising DOWSIL 7657 or 7667. A slot-die coater may distribute the adhesive base material onto backing film 50 at a desired wet thickness (i.e., the thickness of the layer when the platinum-cured silicone adhesive base material composition still contains solvents) corresponding to the amount of solvent present in the adhesive base material. The thickness of the cured layer can be approximated by multiplying the wet film thickness by the proportion of solids in the base material composition. For example, a layer comprising a base material composition is that is 50% solvents and 50% solids by volume, if coated at a wet thickness of 100 microns, will have a dry/cured thickness of 50 microns.

The method further comprises coating a second adhesive layer 62 of platinum-cured silicone adhesive base material composition having a lower strength of adhesion in cured form, such as a composition comprising a mixture of DOWSIL 7667 and DOWSIL 7646 onto the first adhesive layer 60. A slot-die coater may distribute the second adhesive layer 62 onto the first adhesive layer 60 at a desired wet thickness corresponding to the amount of solvent present in the adhesive base material, as the composition still contains solvents.

The desired cured thicknesses T1 of the first adhesive layer 60 and thickness T3 of the second adhesive layer 62 may depend on several factors. In theory, regardless of thickness, the first adhesive layer 60 will provide the desired increase in adhesion between the adhesive layer 51 to the backing film 50. If increased adhesion at this interface is the only objective, a first adhesive layer 60 about 7 microns thick will be acceptable. The 7 micron lower limit on thickness results from practical considerations, because it is difficult to create an acceptable, uniform coating less than 7 microns thick due to the high viscosities of the higher adhesion platinum-cured silicone adhesive base materials, among other factors. In some instances, difficulties due to high viscosities may be remedied through the addition of extra solvent in the base material composition, such as methyl ethyl ketone, due to its low boiling point in comparison with toluene or xylene. Platinum-cured silicone base materials providing greater adhesion in cured form also exhibit greater chemical resistance, however, and thus, where chemical resistance is the objective, the first adhesive layer 60 should be thicker and should comprise the majority of the total thickness of the adhesive layer 51, preferably about 20 microns thick. Moreover, a thicker first adhesive layer 60 also minimizes “squeeze out,” a phenomenon in which the adhesive layer 51 oozes out from under the backing film 50, common when using low adhesion, low viscosity platinum-cured silicone adhesive base materials and when the sealing tape 12 is stored in roll form. Preferably, where chemical resistance is prioritized, the second adhesive layer 62 comprises about ⅕ to about ⅓ of the total thickness of the adhesive layer 51. In one preferred embodiment prioritizing chemical resistance and backing film 50 adhesion, the total thickness of the adhesive layer 51 is 25 microns, the first adhesive layer 60 comprises DOWSIL 7667 adhesive base material and has a thickness of 18 microns, and the second adhesive layer 62 comprises DOWSIL 7652 adhesive base material and having a thickness of 7 microns. In the same preferred embodiment, the backing film comprises polyimide and has a thickness T2 of 25 microns.

Where the objective is acceptable adhesion between the adhesive layer 51 and nozzle plate 18 without damage, however, it may be preferable for the second adhesive layer 62 to be thicker than the first adhesive layer 60. Migration of some of the lower adhesion adhesive base material to the interface between the first adhesive layer 60 and backing film 50 may still provide acceptably strong adhesion between the adhesive layer 51 backing film 50. Moreover, migration and mixing can be controlled and minimized by allowing the first adhesive layer 60 to partially dry or cure before coating it with the second adhesive layer 62, or the first adhesive layer 60 can be loaded with less solvent initially. Thus, where acceptable adhesion is the objective, the second adhesive layer 62 should be thicker and should comprise the majority of the total thickness of the adhesive layer 51, preferably about 20 microns thick. Preferably, the first adhesive layer 60 comprises about 7 microns or more of the total cured thickness of the adhesive layer 51.

The method further comprises one or more curing steps using multi-zone ovens or other suitable equipment. In one variation, the first adhesive layer 60 and second adhesive layer 62 may be coated onto the backing film 50 and cured simultaneously at about 120° C. to 150° C. for about 2 to about 3 minutes. In another variation, the method may comprise curing the first adhesive layer 60 and second adhesive layer 62 sequentially, in two steps. In the first step, the first adhesive layer 60 may be partially cured at 90° C. for 1 minute, after which the first adhesive layer 60 is coated with the second adhesive layer 62. In the second step, the partially cured first adhesive layer 60 and second adhesive layer 62 are cured simultaneously at about 120° C. to 150° C. for about 2 to about 3 minutes. Curing evaporates the solvent present in the adhesive base material composition and creates the cured thicknesses discussed herein.

Without being bound by theoretical considerations, it is believed that the long, flexible siloxane chains of the second adhesive layer 62 may gradually intermix with the first adhesive layer 60 so that there is no clear interface between the first adhesive layer 60 and second adhesive layers 62 as illustrated in FIG. 7, but rather a gradual transition 64 from the first adhesive layer 60 to the second adhesive layer 62. In FIG. 7, the combined adhesive layer 52 is formed from the same thicknesses T3 and T1 of adhesive layer 62 and 60 respectively wherein intermingling of the two layers 60 and 62 provides the gradual transition 64 of the two layer. Thus, the adhesive layer 52 remains strongly adhered to the backing film 50 but cleanly releases from the nozzle plate 18 of the ejection head 20 without damage, without sacrificing the desired properties (such as chemical resistance) of the portion of the adhesive layer 52 in contact with the nozzle plate 18, and without separation of the second adhesive layer 62 from the first adhesive layer 60.

The following non-limiting examples illustrate embodiments of the disclosure. In the following table, formulations may be prepared to provide adhesives with the strengths indicated according to the supplier's information.

TABLE 1

| Component | Ad. 1 | Ad. 2 | Ad. 3 | Ad. 4 | Ad. 5 |
|---|---|---|---|---|---|
| DOWSIL7667 | 100 | 93 | 91 | 87 | 85 |
| (parts by weight) | | | | | |
| DOWSIL 7646 | 0 | 7 | 9 | 13 | 15 |
| (parts by weight) | | | | | |
| SYL-OFF 7678 | 0.4 | 0.405 | 0.406 | 0.409 | 0.411 |
| (parts by weight) | | | | | |
| SYL-OFF 9176 | 0.5 | 0.5 | 0/5 | 0.5 | 0.5 |
| (parts by weight) | | | | | |
| SYL-OFF 4000 | 1.4 | 1.4 | 1.4 | 1.4 | 1.4 |
| (parts by weight) | | | | | |
| TOLUENE | 80 | 85 | 87 | 90 | 91 |
| (parts by weight) | | | | | |
| Bath solids | 0.389 | 0.389 | 0.388 | 0.388 | 0.388 |
| (parts by weight) | | | | | |
| Adhesion N/m | 159.3 | 70.8 | 52.7 | 26.2 | 17.7 |

Adhesive 3 was formulated according to Table 1 and tested for peel strength on a bare silicon wafer as described above. The peel strength was 43 N/m. Adhesive 4 was formulated according to table was tested and was tested for peel strength on a bare silicon wafer as described above. The peel strength was 24.5 N/m.

In some embodiments, the protective tape described herein may be pre-heated prior to filling the cartridge with fluid. It is believed that preheating the protective tape greatly improves the conformity of the protective tape to the cartridge thereby preventing fluid leakage when exposed to heat during shipping and storage.

The fluidic ejection cartridges 10, described above, may be used in variety of applications, including for instance inkjet printing applications. Fluidic ejection cartridges may also be used for other nonprinting applications as well, particularly for applications calling for the precise metering of small amounts of liquid materials and vaporous materials. For example, the ejection cartridges described herein may be used in the preparation of cosmetics, paints, or lubricants and in the ejection of liquids and vapors for medical treatment as well as in digital dispense devices used for analytical purposes.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A removable tape configured for sealing the nozzle plate of an ejection head attached to a fluidic ejection cartridge comprising:
a polymeric backing film;
a first platinum-cured silicone adhesive layer having a first adhesive strength applied to the polymeric backing film; and
a second platinum-cured silicone adhesive layer having a second adhesive strength applied to the first adhesive layer, wherein the second platinum-cured adhesive layer is configured to adhere to the nozzle plate on the ejection head of the fluid ejection cartridge.

2. The removable tape of claim 1, wherein the polymeric backing film is selected from polyethylene terephthalate (PET), polypropylene, polyamide, and polyimide.

3. The removable tape of claim 1, wherein the polymeric backing film has a thickness ranging from about 20 to 30 microns, the first platinum-cured silicone adhesive layer has a thickness on the polymeric backing film ranging from about 7 to about 20 microns, and the second platinum-cured silicone adhesive layer has a thickness on the first platinum-cured silicone adhesive layer ranging from about 7 to about 20 microns.

4. The removable tape of claim 1, wherein the polymeric backing film comprises a corona-treated polymeric backing film.

5. The removable tape of claim 1, wherein the first adhesive strength is greater than the second adhesive strength.

6. The removable tape of claim 1, wherein the first platinum-cured silicone adhesive layer and second platinum-cured silicone adhesive layer comprise different platinum-cured adhesive base materials.

7. The removable tape of claim 6, wherein the first adhesive strength has a peel strength ranging from about 150 to about 500 N/m on a dry silicon wafer and the second adhesive strength has a peel strength ranging from about 25 to about 65 N/m on a dry silicon wafer.

8. The removable tape of claim 1, wherein the first platinum-cured silicone adhesive layer and second platinum-cured silicone adhesive layer comprise the same platinum-cured adhesive base material.

9. The removable tape of claim 8, wherein the first adhesive strength has a peel strength ranging from about 150 to about 500 N/m on a dry silicon wafer and the second adhesive strength has a peel strength ranging from about 25 to about 65 N/m on a dry silicon wafer.

10. A method for making an improved removable tape configured for sealing the nozzle plate of an ejection head attached to a fluidic ejection cartridge, the method comprising:
providing a polymeric backing film;
mixing a crosslinker mixture comprising polydimethylsiloxane and polymethylhydrosilane with a first platinum-cured silicone adhesive base material to provide a first platinum-cured silicone adhesive and with a second platinum-cured silicone adhesive base material to provide a second platinum-cured silicone adhesive;
applying a first layer of the first platinum-cured silicone adhesive having a first adhesive strength to the polymeric backing film;
applying a second layer of the second platinum-cured silicone adhesive layer having a second adhesive strength to the first adhesive layer; and
curing the first and second adhesive layers.

11. The method of claim 10, wherein the method comprises curing the first and second adhesive layers sequentially.

12. The method of claim 11, wherein the curing step comprises partially curing the layer of first platinum-cured silicone adhesive at a temperature of at least about 90° C. for about 1 minute and then curing the layers of first and second platinum-cured silicone adhesive at a temperature of about 120° C. to about 150° C. for about 2 minutes to about 3 minutes.

13. The method of claim 10, wherein the method comprises curing the first and second adhesive layers are cured simultaneously.

14. The method of claim 13, wherein the curing step comprises curing the layers of first and second platinum-cured silicone adhesive at a temperature of about 120° C. to about 150° C. for about 2 minutes to about 3 minutes.

15. The method of claim 10, wherein the first platinum-cured silicone adhesive layer and second platinum-cured silicone adhesive layer comprise different platinum-cured adhesive base materials.

16. The method of claim 10, wherein the first platinum-cured silicone adhesive and second platinum-cured silicone adhesive comprise the same platinum-cured adhesive base materials.

17. The method of claim 15 further comprising the step of mixing a first amount of crosslinker mixture with the first platinum-cured silicone adhesive base material and a second amount of crosslinker mixture with the second platinum-cured silicone adhesive base material, and further wherein the second amount of crosslinker mixture is greater than the first amount of crosslinker mixture.

18. A method for improving the sealing of a nozzle plate of an ejection head attached to a fluidic ejection cartridge, the method comprising:
providing a cartridge body having a cover closing a first end thereof, the ejection head on a second end thereof opposite the first end, and side walls attached to the first and second ends between the first and second ends;
attaching a removable tape to the nozzle plate of the ejection head and to one of the side walls, wherein the removable tape comprises a backing film and a modified platinum-cured silicone adhesive layer having a first adhesive strength adjacent to the backing film and a second adhesive strength less than the first adhesive strength adjacent to the nozzle plate.

19. The method of claim 18 wherein the first adhesive strength has a peel strength on a dry silicon wafer ranging from about 150 to about 500 Newton/meter (N/m) and the second adhesive strength has a peel strength on a dry silicon wafer ranging from about 25 to about 65 N/m.

20. The method of claim 18 wherein the modified platinum-cured silicone adhesive layer has a thickness on the polymeric backing film ranging from about 20 to about 30 microns.
